(19) United States
(12) Patent Application Publication
(10) Pub. No.: US 2018/0087568 A1
(43) Pub. Date: Mar. 29, 2018

(54) AXIAL BEARING ARRANGEMENT

(71) Applicant: Dr. Ing. h.c. F. Porsche Aktiengesellschaft, Stuttgart (DE)

(72) Inventor: Marc Kluge, Besigheim (DE)

(73) Assignee: Dr. Ing. h.c. F. Porsche Aktiengesellschaft, Stuttgart (DE)

(21) Appl. No.: 15/715,655

(22) Filed: Sep. 26, 2017

(30) Foreign Application Priority Data
Sep. 28, 2016 (DE) 102016118360.1

(51) Int. Cl. F16C 19/10; F16C 33/30; F16C 33/38

(52) U.S. Cl. CPC F16C 19/10; F16C 33/3806; F16C 33/30

(57) ABSTRACT

An axial bearing arrangement with a first and second bearing rings that are rotatable relative to each other. First rolling bodies are arranged axially between the rings for supporting the rotation of the two bearing rings. The rolling bodies are arranged running on raceways of the first bearing ring and of the second bearing ring during rotation. At least one third bearing ring is arranged offset axially with respect to the second bearing ring, and therefore the second bearing ring is arranged so as to be rotatable relative to the third bearing ring. Second rolling bodies are arranged axially between the second bearing ring and the third bearing ring for supporting the rotation of the second bearing ring relative to the third bearing ring. The second rolling bodies are arranged running on raceways of the second bearing ring and of the third bearing ring during rotation.

### CROSS-REFERENCE TO RELATED APPLICATIONS

This application claims priority to German Patent Application No. DE 10 2016 118 360.1, filed Sep. 28, 2016, the content of such application being incorporated by reference herein in its entirety.

### FIELD OF THE INVENTION

The invention relates to an axial bearing arrangement, in particular for the mounting of upright rotatable shafts.

### BACKGROUND OF THE INVENTION

For mounting of rotatable shafts, use is made of axial bearing arrangements which have a first bearing ring arid a second bearing ring, wherein the first bearing ring and the second bearing ring are each arranged rotatably in a plane, wherein the planes of the two bearing rings are spaced apart from each other in the axial direction, wherein the two bearing rings are arranged so as to be rotatable relative to each other about an axis of rotation, wherein the axis of rotation is perpendicular to the two planes, and therefore the first bearing ring and the second bearing ring are arranged spaced apart from each other in the axial direction and each extend substantially in a radial direction, and wherein rolling bodies are arranged axially between the first bearing ring and the second bearing ring, said rolling bodies being arranged running on raceways of the first bearing ring and of the second bearing ring during rotation, for supporting the rotation of the two bearing rings.

At high axial loads and in particular at high static loads in the axial direction on the first bearing ring and/or on the second bearing ring and in particular when vibrations occur, the rolling bodies can dig into the raceways of the bearing rings, which permanently damages or destroys the bearing. This disadvantageous effect is further reinforced in the case of static loads due to vibrations which occur.

### SUMMARY OF THE INVENTION

Described herein is an axial bearing arrangement which reduces or even avoids the disadvantages of the prior art. Also described herein is method for driving a bearing ring of an axial bearing arrangement.

An exemplary embodiment of the invention relates to an axial bearing arrangement with a first bearing ring and with a second bearing ring, wherein the first bearing ring and the second bearing ring are each arranged rotatably in a plane, wherein the planes of the first bearing ring and of the second bearing ring are spaced apart from each other in the axial direction, wherein the first bearing ring and the second bearing ring are arranged so as to be rotatable relative to each other about an axis of rotation, wherein the axis of rotation is perpendicular to the two planes of the first bearing ring and of the second bearing ring, and therefore the first bearing ring and the second bearing ring are arranged spaced apart from each other in the axial direction and so as to be rotatable relative to each other and each extend substantially in a radial direction, and wherein first rolling bodies are arranged axially between the first bearing ring and the second bearing ring, said rolling bodies being arranged running on raceways of the first bearing ring and of the second bearing ring during rotation, for supporting the rotation of the two bearing rings, wherein at least one third bearing ring is arranged offset axially with respect to the second bearing ring, and therefore the second bearing ring is arranged so as to be rotatable relative to the third bearing ring, and wherein second rolling bodies are arranged axially between the second bearing ring and the third bearing ring, said rolling bodies being arranged running on raceways of the second bearing ring and of the third bearing ring during rotation, for supporting the rotation of the second bearing ring relative to the third bearing ring. The effect can thereby be achieved that the load even of upright elements is distributed better and rotation of bearing rings can also be brought about without the upright element, such as an upright shaft, having to be moved in the process, which reduces the wear.

It is particularly advantageous here if the second bearing ring is of single-part design and has raceways on both sides for the first rolling bodies and for the second rolling bodies. A compact solution can therefore be found.

In a further concept according to aspects of the invention, it is also advantageous if the second bearing ring is of two-part design in such a manner that a fourth bearing ring which is arranged adjacent to the second bearing ring is arranged in such a manner that the second rolling bodies which are arranged axially between the second bearing ring and the third bearing ring are thereby arranged between the fourth bearing ring and the third bearing ring and are arranged running on raceways of the fourth bearing ring and of the third bearing ring during rotation, for supporting the rotation of the fourth bearing ring relative to the third bearing ring. An arrangement which can be formed by duplicating two axial bearings can thus be found.

Furthermore, it is advantageous if the design of the first bearing ring and of the second bearing ring with the first rolling bodies is substantially identical to the design of the third bearing ring and of the fourth bearing ring, wherein the fourth bearing ring is arranged adjacent to the second bearing ring. By the use of two identical bearings, the outlay on costs and logistics can thus be kept lower.

It is particularly expedient if the second bearing ring and/or the fourth bearing ring are drivable via a driving element. As a result, the respective bearing ring can be set into movement, and therefore no local digging in can arise or said digging in can be distributed uniformly over the circumference, which increases the service life.

It is also particularly advantageous if the second bearing ring, and/or the fourth bearing ring has/have an internal toothing or an external toothing which is driven by a gearwheel driven by an actuator. As a result, the coupling to an actuator as the drive can be directly integrated in or on the corresponding bearing ring.

It is also advantageous if the raceways of the first rolling bodies and of the second rolling bodies have an identical radius. As a result, the first and the second rolling bodies are located one above the other substantially in the axial direction, and therefore a more uniform loading is achieved.

Also described herein is a method for driving a bearing ring of an axial bearing arrangement, such as an axial bearing, in particular a second or a fourth bearing ring according to the axial bearing arrangement according to aspects of the invention, with an actuator for driving the bearing ring, wherein the drive is activated permanently in terms of time, periodically in terms of time or stochastically in terms of time in order at least temporarily to set the bearing ring into rotation.

### BRIEF DESCRIPTION OF THE DRAWINGS

The invention is explained in detail below using are exemplary embodiment with reference to the drawing. In the drawing:

FIG. 1 shows an illustration of an axial bearing arrangement according to the prior art,

FIG. 2 shows an illustration of an axial bearing arrangement according to an exemplary embodiment of the invention, and

FIG. 3 shows an illustration of an axial bearing arrangement according to a further exemplary embodiment of the invention.

### DETAILED DESCRIPTION OF THE INVENTION

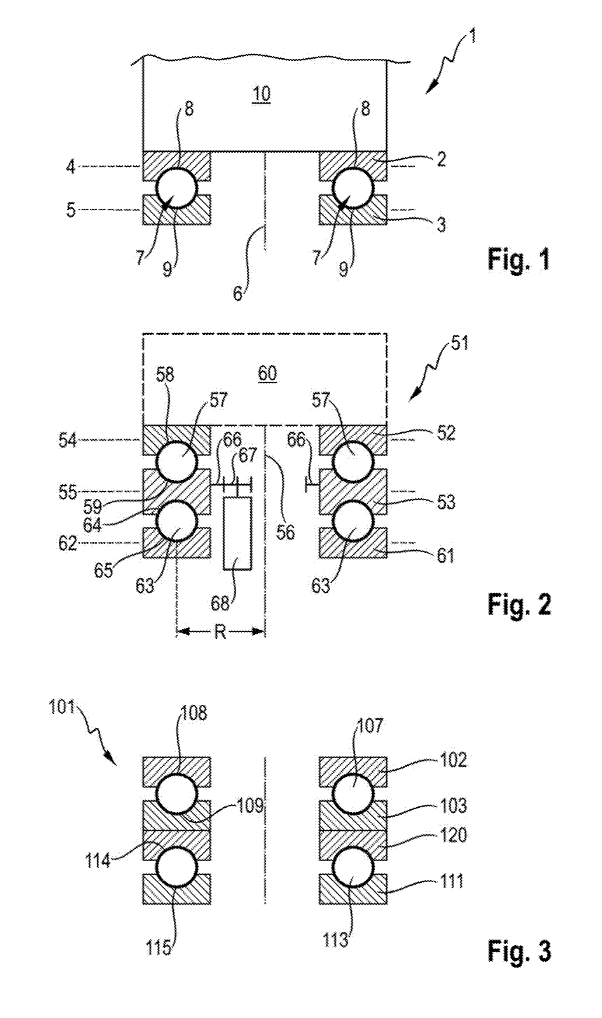

FIG. 1 shows an axial bearing arrangement 1 according to the prior art with a first bearing ring 2 and with a second bearing ring 3. The first bearing ring 2 and the second bearing ring 3 are each arranged rotatably in a plane 4, 5, wherein the planes 4, 5 of the first bearing ring 2 and of the second bearing ring 3 are spaced apart from each other in the axial direction, wherein the first bearing ring 2 and the second bearing ring 3 are arranged so as to be rotatable relative to each other about an axis of rotation 6. The axis of rotation 6 is arranged here perpendicular to the two planes 4, 5 of the first bearing ring 2 and of the second bearing ring 3. The first bearing ring 2 and the second bearing ring 3 are therefore arranged spaced apart from each other in the axial direction and are arranged so as to be rotatable relative to each other. The two bearing rings 2, 3 each extend substantially in a radial direction with respect to the axis of rotation 6.

First rolling bodies 7 are arranged axially between the first bearing ring 2 and the second bearing ring 3, said rolling bodies being arranged running on raceways 8, 9 of the first bearing ring 2 and of the second bearing ring 3 during rotation, for supporting the rotation of the two bearing rings 2, 3.

As a result, a load 10 perpendicular to the bearing ring 2 can be supported axially.

FIG. 2 shows an axial bearing arrangement 51 according to aspects of the invention with a first bearing ring 52, with a second bearing ring 53 and with a third bearing ring 61. The first bearing ring 52 and the second bearing ring 53 and also the third bearing ring 61 are each arranged rotatably in a plane 54, 55, 62, wherein the planes 54, 55, 62 of the first bearing ring 52, of the second bearing ring 53 and of the third bearing ring 61 are spaced apart from one another in the axial direction, wherein the first bearing ring 52, the second bearing ring 53 and the third bearing ring 61 are arranged so as to be rotatable relative to one another about an axis of rotation 56. The axis of rotation 56 here is perpendicular to the planes 54, 55 and 62 of the first bearing ring, the second bearing ring and the third bearing ring 61.

The first bearing ring 52, the second bearing ring 53 and the third bearing ring 61 are therefore arranged spaced apart from one another in the axial direction and are arranged so as to be rotatable relative to one another. The bearing rings 52, 53 and 61 each extend substantially in a radial direction with respect to the axis of rotation 56.

First rolling bodies 57 and second rolling bodies 63 are respectively arranged axially between the first bearing ring 52 and the second bearing ring 53 and also axially between the second bearing ring 53 and the third bearing ring 61, said rolling bodies being arranged running on raceways 58, 59, 64, 65 of the first bearing ring 52 and of the second bearing ring 53 during rotation, for supporting the rotation of the bearing rings 52, 53 and 61.

As a result, a load 60 which is perpendicular to the bearing ring 52 can be supported axially.

The exemplary embodiment of FIG. 2 shows, in the case of the axial bearing arrangement 51, that at least one third bearing ring 61 is arranged offset axially with respect to the second bearing ring 53, and therefore the second bearing ring 53 is arranged rotatably relative to the third bearing ring 61. Second rolling bodies 63 are also arranged axially between the second bearing ring 53 and the third bearing ring 61, said rolling bodies being arranged running on raceways 64, 65 of the second bearing ring 53 and of the third bearing ring 51 during rotation, for supporting the rotation of the second bearing ring 53 relative to the third bearing ring 61.

It can also be seen in FIG. 2 that the second bearing ring 53 is of single-part design and has raceways 59, 64 on both sides for the first rolling bodies 57 and for the second rolling bodies 63. It is also advantageous here that the raceways 58, 59 and 64, 65 of the first rolling bodies 57 and of the second rolling bodies 63 have an identical radius R.

FIG. 2 also shows that the second bearing ring 53 is drivable via a driving element. For this purpose the second bearing ring 53 has an internal toothing 66, alternatively also an external toothing, which is driven by a gearwheel 67 driven by an actuator 68.

As a result, a method for driving a bearing ring 53 of an axial bearing arrangement 51, such as in particular an axial bearing, in particular a second bearing ring 53, can be carried out or used, with an actuator 68 for driving the bearing ring 53. The drive here can be activated permanently in terms of time, periodically in terms of time or stochastically in terms of time in order to at least temporarily set the bearing ring 53 into rotation, i.e., permanently, periodically or at stochastic points in time and optionally over a fixedly predetermined period of time or over a variable period of time.

FIG. 3 shows an exemplary embodiment as a modification of the exemplary embodiment of FIG. 2.

FIG. 3 shows an axial bearing arrangement 161 of the axial bearing arrangement 51 of FIG. 2, wherein the second bearing ring 103 as per the second bearing ring 53 of FIG. 2 is now of two-part design in such a manner that a fourth bearing ring 120 which is arranged adjacent to the second bearing ring 103 is arranged in such a manner that the second rolling bodies 113 arranged axially between the second bearing ring 103 and the third bearing ring 111 are thereby arranged between the fourth bearing ring 120 and the third bearing ring 111 and arranged running on raceways 114, 115 of the fourth bearing ring 120 and of the third bearing ring 111 during rotation, for supporting the rotation of the fourth bearing ring 120 and of the second bearing ring 103 relative to the third bearing ring 111. The second bearing ring 103 rests here on the fourth bearing ring 120.

The design of the first bearing ring 102 and of the second bearing ring 103 with the first rolling bodies 107 is substantially identical to the design of the third bearing ring 111 and of the fourth bearing ring 120, wherein the fourth bearing ring 120 is arranged adjacent to the second bearing ring 103. It is therefore also possible to arrange two structurally identical axial bearings.

In accordance with the design according to FIG. 2, in the case of the exemplary embodiment of FIG. 3, the second bearing ring 103 and/or the fourth bearing ring 120 can be drivable via a driving element in such a manner that the second bearing ring 103 and/or the fourth bearing ring 120 has or have an internal toothing or an external toothing which is or are driven by a gearwheel 67 driven by an actuator 68.

FIG. 3 also shows that the raceways 108, 109 of the first rolling bodies 107 and the raceways 114, 115 of the second rolling bodies 113 have an identical radius.

The activation for driving the second and/or the fourth bearing ring can likewise take place by the fact that the drive takes place permanently in terms of time, periodically in terms of time or stochastically in terms of time in order at least temporarily to set the bearing ring or the bearing rings into rotation.

### LIST OF REFERENCE NUMBERS

1 Axial bearing arrangement

2 First bearing ring

3 Second bearing ring

4 Plane

5 Plane

6 Axis of rotation

7 First rolling bodies

8 Raceway

9 Raceway

10 Load

51 Axial bearing arrangement

52 First bearing ring

53 Second bearing ring

54 Plane

55 Plane

56 Axis of rotation

57 First rolling bodies

58 Raceway

59 Raceway

60 Load

61 Third bearing ring

62 Plane

63 Second rolling bodies

64 Raceway

65 Raceway

66 Internal toothing

67 Gearwheel

68 Actuator

101 Axial bearing arrangement

102 First bearing ring

103 Second bearing ring

107 First rolling bodies

108 Raceway

109 Raceway

111 Third bearing ring

113 Second rolling bodies

114 Raceway

115 Raceway

120 Fourth bearing ring

What is claimed is:

1. An axial bearing arrangement comprising:
a first bearing ring and a second bearing ring, wherein the first bearing ring and the second bearing ring are each arranged rotatably in a plane, wherein the planes of the first bearing ring and of the second bearing ring are spaced apart from each other in an axial direction,
wherein the first bearing ring and the second bearing ring are arranged so as to be rotatable relative to each other about an axis of rotation, wherein the axis of rotation is perpendicular to the two planes of the first bearing ring and of the second bearing ring, and the first bearing ring and the second bearing ring being spaced apart from each other in the axial direction and rotatable relative to each other, and each bearing ring extending substantially in a radial direction, and
first rolling bodies for supporting rotation of the two bearing rings and being arranged axially between the first bearing ring and the second bearing ring, said first rolling bodies running on raceways of the first bearing ring and of the second bearing ring during rotation,
at least one third bearing ring offset axially with respect to the second bearing ring, and the second bearing ring being arranged so as to be rotatable relative to the third bearing ring, and
second rolling bodies for supporting rotation of the second bearing ring relative to the third bearing ring, and being arranged axially between the second bearing ring and the third bearing ring, said second rolling bodies running on raceways of the second bearing ring and of the third bearing ring during rotation.

2. The axial bearing arrangement as claimed in claim 1, wherein the second bearing ring is of single-part design and has raceways on both sides for the first rolling bodies and for the second rolling bodies.

3. The axial bearing arrangement as claimed in claim 1, wherein the second bearing ring is of two-part design in such a manner that a fourth bearing ring which is arranged adjacent to the second bearing ring is arranged in such a manner that the second rolling bodies support rotation of the fourth bearing ring relative to the third bearing ring, wherein the second rolling bodies are arranged (i) axially between the second bearing ring and the third bearing ring, (ii) between the fourth bearing ring and the third bearing ring, and (iii) running on raceways of the fourth bearing ring and of the third bearing ring during rotation.

4. The axial bearing arrangement as claimed in claim 3, wherein the first bearing ring and the second bearing ring are substantially identical to the third bearing ring and the fourth bearing ring, wherein the fourth bearing ring is arranged adjacent to the second bearing ring.

5. The axial bearing arrangement as claimed in claim 3, wherein the second bearing ring or the fourth bearing ring are drivable via a driving element.

6. The axial bearing arrangement as claimed in claim 5, wherein either the second bearing ring or the fourth bearing ring has an internal toothing or an external toothing which is driven by a gearwheel driven by an actuator.

7. The axial bearing arrangement as claimed in claim 3, wherein the raceways of the first rolling bodies and of the second rolling bodies have an identical radius.

8. A method for driving one of the bearing rings of the axial bearing arrangement of claim 1 using an actuator, the method comprising the step of activating the actuator either permanently, periodically or randomly in terms of time in order to at least temporarily set the bearing ring into rotation.
